(19) United States
(12) Patent Application Publication
(10) Pub. No.: US 2012/0068551 A1
(43) Pub. Date: Mar. 22, 2012

(54) ELECTRICAL-ENERGY STORAGE DEVICES

(75) Inventors: David Martin Pooley, Stapleford (GB); Oleksandr Hoshtanar, Cambridge (GB)

(73) Assignee: ACCESS BUSINESS GROUP INTERNATIONAL LLC, Ada, MI (US)

(21) Appl. No.: 13/322,209

(22) PCT Filed: May 19, 2010
(86) PCT No.: PCT/US10/35371

§ 371 Date: Nov. 23, 2011

(30) Foreign Application Priority Data
May 27, 2009 (GB) 0909101.8

(51) Int. Cl. H02J 17/00; H01M 10/02; H01M 10/36; H01G 9/155; H01M 2/02; H01M 4/04; H01G 9/04; H01M 4/02; H01M 10/42

(52) U.S. Cl. 307/104; 429/209; 429/152; 429/94; 429/7; 429/163; 29/623.1; 29/25.03; 361/502

(57) ABSTRACT

An electrical-energy storage device configured for use in a time-varying electromagnetic field, the storage device comprising: an electrode at least part of which is configured so as to hinder the ability of eddy currents induced by said field to circulate therein.

### BACKGROUND OF THE INVENTION

The present invention relates to electrical-energy storage devices, and to equipment (e.g. electrical or electronic devices) having such storage devices. More particularly, the present invention relates to electrical-energy storage devices for use in time-varying electromagnetic fields, for example in inductive charging systems.

Electrical-energy storage devices are generally devices which are used to store electrical energy (albeit possibly in chemical form) for later use, and may be rechargeable. Such storage devices may store electrical energy for a relatively short amount of time (e.g. milliseconds) or for a relatively long amount of time (e.g. hours). Many different types of electrical-energy storage devices are known, for example batteries (e.g. rechargeable lithium-based batteries), supercapacitors (e.g. electrochemical double-layer capacitors) and hybrid battery-capacitor devices. Batteries, for example, may store electrical energy in the form of chemical energy that can be converted, when needed, into electric potential energy to drive an electric current.

It is known to charge electrical-energy storage devices (e.g. batteries) in inductive power transfer systems. The use of electrical-energy storage devices in time-varying electromagnetic fields, for example in such inductive charging systems, can be problematic in view of thermal considerations. For example, some lithium-based secondary cell technologies have a maximum temperature limit of 45° C. during charging for safety reasons. Any losses occurring during charging contribute to a temperature rise. If the magnetic field used during charging extends into the electrical-energy storage device itself, then it has been found that losses may occur due to eddy-current heating of any conductive components. These losses impact thermal considerations as the losses manifest themselves as heat generated directly within the electrical-energy storage device.

### SUMMARY OF THE INVENTION

According to an embodiment of a first aspect of the present invention, there is provided an electrical-energy storage device configured for use in a time-varying electromagnetic field, the storage device including: an electrode at least part of which is configured so as to hinder the ability of eddy currents induced by the field to circulate therein.

It can be advantageous to hinder the ability of eddy currents to circulate, because circulation of such eddy currents generates heat. In one embodiment, the electrode part may be configured to substantially reduce or even prevent such eddy currents from circulating.

The part of the electrode may be shaped to hinder the ability of eddy currents induced by the field to circulate therein. That is, the physical structure of the part of the electrode may be effective in hindering circulation of eddy currents. The structure of the part of the electrode may, for example, have a pattern which hinders the ability of eddy currents induced by the field to circulate therein. The pattern may, for example, be visible on inspection of the electrode. The part of the electrode may be configured such that there are substantially no, or relatively few, closed loops around which eddy currents may flow.

The part of the electrode may be metallic. For example, it may be made of a metal. Examples of suitable materials include carbon (e.g. for anodes), metal oxides (e.g. for cathodes), such as LiCoO₂, LiMnO₂, LiFePO₄, Li₂FePO₄F), lithium or lithium-carbon (e.g. for anodes), copper, aluminium, silver, silver-loaded ink, or carbon.

In one embodiment, the part of the electrode may be in the form of one or more fingers electrically connected to the rest of the electrode at one end only. That is, there may be provided an electrical-energy storage device configured for use in a time-varying electromagnetic field, the storage device including: an electrode at least part of which is in the form of one or more fingers electrically connected to the rest of the electrode at one end only. Such a finger may be a generally elongate member, or an extremity, or a protrusion. The or each finger may, for example, have one or more sub-fingers protruding therefrom. The or each finger may be generally regular in shape, or may be substantially irregular in shape. By being connected at one end only, such a finger may not form part of a closed loop (which it may otherwise do if its ends were connected together). The or each finger may be generally narrow compared to a width of the electrode and/or the part of the electrode.

The or each finger may have a constant or varying cross-section along its length. For example, the or each finger may have a substantially square or rectangular cross-section. In one embodiment, the or each finger may have a circular or triangular cross-section.

The or each finger may be dimensioned so as to hinder the ability of eddy currents induced by the field to circulate therein. That is, each finger may be small enough in each of its dimensions (length, width, thickness) such that eddy currents are hindered from circulating it that finger itself.

The part of the electrode may be in the form of a plurality of such fingers electrically connected together at one end only. That is, there may be provided an electrical-energy storage device configured for use in a time-varying electromagnetic field, the storage device including: an electrode at least part of which is in the form of a plurality of such fingers electrically connected together at one end only. Such a structure may resemble a hand or a comb. The fingers and such an electrical connection therebetween may make up substantially all of the part of the electrode. The electrical connection itself may make up a minor portion of the part of the electrode, the fingers making up a major portion of the part of the electrode. In that way, the part of the electrode may have substantially no closed loops around which eddy currents may flow.

The fingers may be substantially straight, and each finger may have a substantially uniform width along its length. Indeed, the fingers of the electrode may have substantially the same width and length as one another. Such a uniform structure may render the electrode relatively easy and inexpensive to manufacture. The electrode part may be, for example, generally laminar, such as a sheet, which may be planar. Such length and width dimensions may be measured in the plane of the sheet (which plane may be curved), and a thickness dimension may be measured perpendicularly to that plane.

A width of the fingers of the electrode may be substantially small compared to a width or a length of the electrode part. For example, the part of the electrode may be made up of a large number of narrow fingers. The narrower the fingers, the less prone they may be to the circulation therein of eddy currents. By way of example, a width of the fingers of the electrode may be less than 0.25 mm and optionally in the range 0.1 to 0.2 mm.

A width of a spacing or each such spacing between adjacent fingers of the electrode may be substantially small compared to a width or a length of the electrode part. The narrower the spacings, the more complete the plane of the electrode and the better the general electrical performance of that electrode. By way of example, a width of a spacing or each such spacing between adjacent fingers of the electrode may be less than 0.25 mm and optionally in the range 0.1 to 0.2 mm.

The width of the spacings and the fingers may, for example, be the same as one another, and generally uniform. This may facilitate the manufacture of such electrodes.

The fingers of the electrode may be all joined to the same common portion of the electrode, for example as in the structure of a comb. The common portion may be located toward, or even at/along, one side of the electrode, such that the fingers project from that side to the opposite side of the electrode. The electrode may include two sets of such fingers projecting in opposite directions from the common part of the electrode. In that case, the common portion may be located towards the centre of the part of the electrode.

The part of the electrode having the fingers may be generally in the form of a sheet having one or more slits therein each forming a spacing between adjacent fingers of the electrode. The sheet may be substantially flat, or it may be curved or rolled or folded or take some other three-dimensional form.

The storage device may include a plurality of such electrodes whose parts generally in the form of a sheet are layered one on top of the other in a stack. The stack may include layers of electrolyte or separating layers interleaved between adjacent such electrodes. The storage device may have a prismatic form, wherein the stack is provided in a flat configuration within the storage device. The storage device may have a cylindrical form, wherein the stack is provided in a rolled configuration within the storage device. The storage device may have another form, for example a so-called “button” or “coin” form.

The time-varying electromagnetic field may have a fundamental frequency, i.e. a main or tuned frequency at which the field varies or fluctuates. A thickness of the sheet for the or each electrode may be less than a predetermined fraction of a skin depth at the fundamental frequency. In this way, the magnetic field may penetrate or pass through the part of the electrode with little or no loss.

The fundamental frequency may vary depending on the application. In one embodiment, the fundamental frequency may be in the range of a few tens of kHz to a few tens of MHz, optionally in the range 10 to 500 kHz, for example 323 kHz. The predetermined fraction may vary depending on the application. In one embodiment, the predetermined fraction may be in the range ⅕ to 1/30, for example ⅙ or 1/20.

In the case where the storage device has a plurality of electrodes, a combination of the thicknesses of the electrode parts may be less than the predetermined fraction of a skin depth at the fundamental frequency.

The sheet for the or each electrode may be formed of, for example, an aluminium sheet with a thickness of around 0.01 mm to 0.2 mm (e.g. 0.01 mm).

The or each electrode may include a metallic sheet having the part including one or more fingers provided on a face of a polymer substrate. The or each polymer substrate may be continuous, not having such a finger or such fingers. The or each electrode may include two such metallic sheets provided on opposite faces of the same polymer substrate.

Example materials for the substrate include PET (Polyethylene Terephthalate), PI (Polyimide), mylar, PTFE (Polytetrafluoroethylene), FR-4 (Flame Retardent 4), and CEM-3 (Composite Epoxy Material 3). Such a substrate could be, for example, 0.01 mm to 0.2 mm thick. For example, 0.05 mm PET could be a suitable substrate material. Such a material may lead to a flexible-PCB-type electrode.

The storage device may have a casing, such as a foil casing, and that casing may have a thickness less than a predetermined fraction of a skin depth at the fundamental frequency of the field. In this way, the magnetic field may penetrate or pass through the part casing with little or no loss. The casing may, for example, be around 10 to 30 microns thick.

The storage device may include a coil for receiving power inductively when in such a time-varying electromagnetic field. That is, the storage device may be equipped to serve as a secondary unit in an inductive power transfer system.

According to an embodiment of a second aspect of the present invention, there is provided an electrical-energy storage device configured for use in a time-varying electromagnetic field, the storage device including: an electrode at least part of which is generally in the form of a sheet having one or more slits therein passing from within the sheet to an edge of the sheet and arranged such that the sheet is in the form of a plurality of strips connected together at one end only. The electrode so configured may be usable within such an electromagnetic field without significant losses due to eddy currents.

According to an embodiment of a third aspect of the present invention, there is provided an electrical-energy storage device configured for use in a time-varying electromagnetic field, the storage device including: an electrode including a plurality of strips connected together so as to hinder the ability of eddy currents induced by the field to circulate therein. The electrode so configured may be usable within such an electromagnetic field without significant losses due to eddy currents.

According to an embodiment of a fourth aspect of the present invention, there is provided an electrical-energy storage device configured for use in a time-varying electromagnetic field whose variations have a fundamental frequency, the storage device including: an electrode at least part of which is generally in the form of a sheet whose thickness is less than a predetermined fraction of a skin depth at the fundamental frequency. The electrode so configured may be usable within such an electromagnetic field without significant losses as the field penetrates the electrode.

The fundamental frequency may vary depending on the application. In one embodiment, the fundamental frequency may be in the range of a few tens of kHz to a few tens of MHz, optionally in the range 10 to 500 kHz, for example 323 kHz. The predetermined fraction may vary depending on the application. In one embodiment, the predetermined fraction may be in the range ⅕ to 1/30, for example ⅙ or 1/20.

The storage device may include a plurality of such electrodes whose parts generally in the form of a sheet are layered one on top of the other in a stack. A combination of the thicknesses of the electrode parts may be less than the predetermined fraction of a skin depth at the fundamental frequency.

The part of the or each electrode may be a major part of, or substantially all of, that electrode.

According to an embodiment of a fifth aspect of the present invention, there is provided an electrical-energy storage device configured for use in a time-varying electromagnetic field whose variations have a fundamental frequency, the storage device including: a casing, such as a foil casing, whose thickness is less than a predetermined fraction of a skin depth at the fundamental frequency. The casing so configured may be usable within such an electromagnetic field without significant losses as the field penetrates the casing.

The storage device may be any type of electrical-energy storage device, such as a battery or a supercapacitor or a hybrid battery-capacitor device.

According to an embodiment of a sixth aspect of the present invention, there is provided an electrical or electronic device including a storage device according to any of the aforementioned first to fifth aspects of the present invention. Such a device may be any electrical or electronic device which requires electrical power, and may be a portable such device, for example a mobile phone, PDA (Personal Digital Assistant), laptop computer, personal stereo equipment, an MP3 player and the like, a wireless headset, a vehicle charging unit, a home appliance such as a kitchen appliance, a personal card such as a credit card, and a wireless tag useful for tracking merchandise.

Such an electrical or electronic device may be suitable for receiving power wirelessly by electromagnetic induction when located in a time-varying electromagnetic field, the electrical or electronic device further including: a coil configured to couple with such a field so that a current is induced therein; and circuitry for providing the current to the storage device and/or to other circuitry in the electrical or electronic device so as to provide the received power thereto. The coil may be positioned adjacent to the storage device, such that the storage device is well within the field when the coil is in use, as the storage device is configured to cause low losses associated with the electromagnetic field.

According to an embodiment of a seventh aspect of the present invention, there is provided a combination, including a storage device according to any of the aforementioned first to fifth aspects of the present invention and a coil for use in receiving power inductively when in such a time-varying electromagnetic field.

According to an embodiment of an eighth aspect of the present invention, there is provided an inductive power transfer system, including: a primary unit having a primary coil operable to generate a time-varying electromagnetic field; and a secondary unit suitable for receiving power wirelessly by electromagnetic induction from the primary unit when located in the time-varying electromagnetic field, the secondary unit including: a secondary coil configured to couple with the field so that a current is induced therein; a storage device according to any of the aforementioned first to fifth aspects of the present invention; and circuitry for providing the current to the storage device and/or to other circuitry in the secondary unit so as to provide the received power thereto. Because such a storage device is configured to cause low losses associated with the electromagnetic field, the primary unit may, for example, be a cost-reduced primary unit, since it may be less efficient than a primary unit in a system not benefiting from embodiments of the present invention.

According to an embodiment of an ninth aspect of the present invention, there is provided a method of manufacturing a storage device according to any of the aforementioned first to fifth aspects of the present invention, the method including: forming the finger or fingers by photolithography and chemical etching, or by a screen printing process, or by a stamping process.

According to an embodiment of a tenth aspect of the present invention, there is provided an electrical component configured for use in a time-varying electromagnetic field, the component including an electrical terminal or plate at least a part of which is configured so as to hinder the ability of eddy currents induced by the field to circulate therein. For example, that part may be in the form of a plurality of fingers connected together at one end only. Such a component may be, for example, a capacitor or a battery or any other electrical component.

Optional features of one aspect may apply equally to another aspect, and vice versa.

### BRIEF DESCRIPTION OF THE DRAWINGS

Reference will now be made, by way of example, to the accompanying drawings, of which:

FIG. 1 is a schematic diagram of the structure of a battery according to one embodiment of the present invention;

FIG. 2 is a schematic topological view of a part of an electrode of a battery according to one embodiment of the present invention;

FIGS. 3A and 3B are schematic diagrams illustrating possible arrangements of a secondary coil relative to a battery according to one embodiment of the present invention;

FIGS. 4A and 4B are plots showing typical absorption (loss) and reflection coefficients for different thickness layers of different materials;

FIG. 5 is a schematic topological view of a part of an electrode for use in a battery according to one embodiment of the present invention;

FIG. 6 is a schematic diagram useful for appreciating two possible forms of a battery according to different embodiments of the present invention; and

FIG. 7 is a schematic diagram of an inductive power transfer system according to one embodiment of the present invention.

### DESCRIPTION OF THE CURRENT EMBODIMENTS

Although the embodiments disclosed relate to batteries, it will be appreciated that those embodiments are only example implementations of the present invention. The present invention is to be understood to relate more generally to electrical-energy storage devices (for example, energy storage devices for use in circuitry).

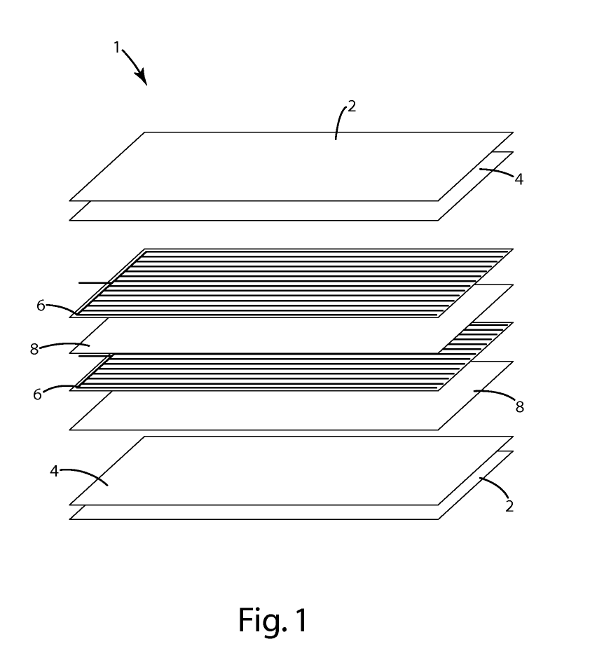

FIG. 1 is a schematic diagram of the structure of a battery 1 according to one embodiment of the present invention. Battery 1 has a generally stacked structure of layers, including a foil case 2 at the outer ends of the structure, with a spacer 4 inwardly adjacent thereto. Between these outer elements is provided a central set of layers including electrodes 6 and electrolyte/separator layers 8.

Typically, the central layers are configured such that the layers alternate between electrodes 6 and electrolyte/separator layers 8, for example in the form positive electrode-electrolyte-negative electrode-electrolyte, and this pattern may be repeated several times, for example 10 to 20 times. Of course, this arrangement is one example arrangement of the central layers, and other arrangements could form other embodiments of the present invention.

Although not shown in FIG. 1 for simplicity, the foil case 2 (and possibly also the spacer 4) may form a shell around the central layers, for example acting as a sealed container (terminals for the electrodes passing therethrough).

The battery in the present embodiment is a lithium-ion polymer (lithium polymer) battery, although the other embodiments could employ a different cell technology (e.g. nickel metal hydride, nickel cadmium, etc.). It will be appreciated that supercapacitors typically use a similar layer structure to lithium polymer cells, and thus supercapacitors embodying the present invention may be formed in a similar fashion to the battery embodiments disclosed herein.

The lithium-polymer cell technology is well suited to the present invention as the requirements on the casing layer 2 are less stringent than in other technologies. For example, in lithium-polymer-cell-technology batteries, the casing is not required to act as a pressure vessel, and hence can be fairly thin.

In the present embodiment, the foil casing 2 is configured to have a thickness that is a small fraction of a skin depth at the fundamental frequency (drive frequency) of the electromagnetic field in which the battery is designed to operate.

In one embodiment, the drive frequency may be expected to be anything from tens of kHz up to tens of MHz. In the present embodiment, it is assumed by way of example that the battery is intended to operate in a time-varying field (typical of an inductive power transfer system) with a drive frequency of a few hundred kilohertz, for example 323 kHz. However, it will be appreciated that dimensions and other values provided herein are by way of example, and the values may be adjusted to suit other frequencies.

In the present embodiment, the foil casing 2 is 10 to 30 microns thick aluminium foil. By being a small fraction (e.g. ⅙ or 1/20) of a skin depth at the example drive frequency, the foil casing 2 allows the magnetic field to pass therethrough with little or no losses. Such a thin casing may be strengthened by being attached to a thicker polymer backing material, such as or as well as spacer 4, or by enclosing the battery in whole or in part in a plastic case (not shown), which may be rugged. A polymer layer alone may however be used instead of the foil casing 2, provided it has suitable mechanical properties (for support) and chemical properties such as permeability (e.g. an oxygen barrier coating).

The electrodes 6 in the present embodiment are configured such that they have a thickness which is a very small fraction of a skin depth at the example drive frequency, and again this allows the magnetic field to pass therethrough with little or no losses. This may be achieved by using low conductivity materials such as conductive polymers or carbons.

Skin depth for a particular material may, briefly, be calculated as follows:

$$δ = \sqrt{\frac{2}{σ \cdot μ \cdot ω}}$$

where:
δ is the skin depth;
σ is the material conductivity;
μ is the material permeability; and
ω is the angular frequency of the field (frequency in hertz multiplied by 2π).

For more-highly-conductive materials (e.g. metallic materials such as metals), the electrodes may be patterned into a shape where there are no, or few, closed loops around which eddy currents might flow, such eddy currents being generated by the electromagnetic field in which the battery is designed to operate. Such eddy currents may cause losses manifested as heat, and the present embodiment is configured to reduce such losses, i.e. to have low eddy-current losses at the driving frequency, or generally at any frequency.

The electrodes may, in one embodiment, be formed from patterned layers that are conductive, but not made of metal. For example, such layers may be of carbon or metal oxide materials.

In the present embodiment, as can be seen from FIG. 1, the electrodes 6 are configured such that they have a part that has a set of comb-like fingers. Such patterning may be performed by photolithography and chemical etching of a layer of metal on a substrate, or by another method such as screen printing or stamping.

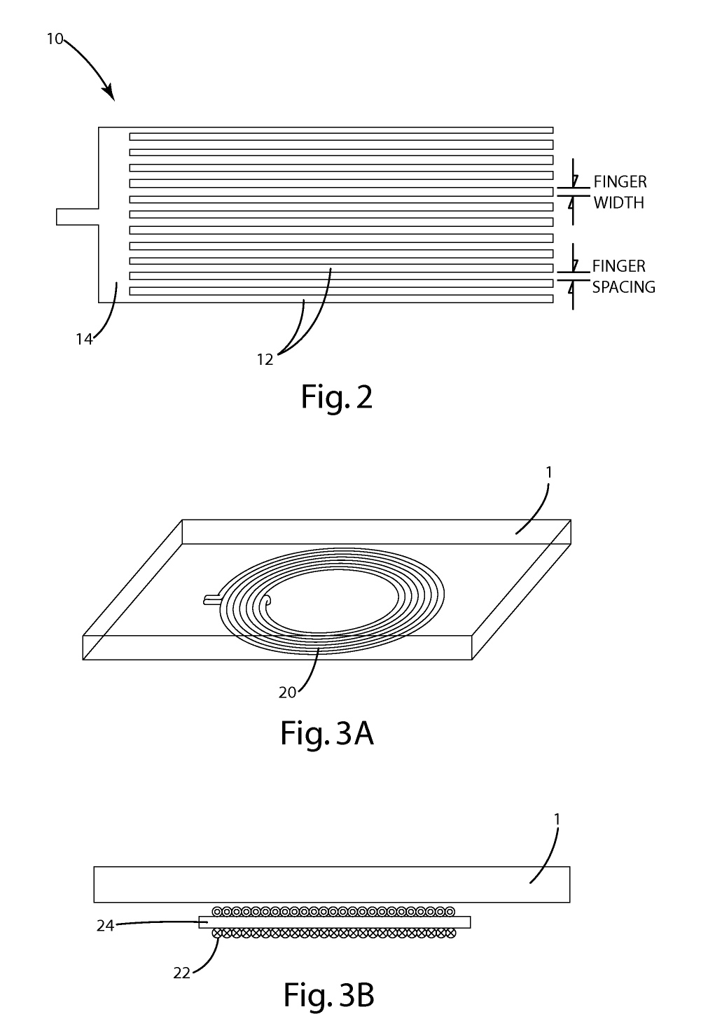

FIG. 2 is a schematic topological view of a part 10 of an electrode 6.

Electrode part 10 includes a set of fingers 12 connected together at one end to a common portion 14. In the present embodiment, the fingers 12 are generally straight, of uniform width and uniformly spaced apart, such that the overall shape resembles that of a comb. Of course, in other embodiments of the present invention, the fingers could be of non-uniform shape and spacing.

In the present embodiment, the finger widths and spacings are substantially the same as one another, and are in the range 0.1 mm to 0.2 mm. These widths and spacings may be selected to provide acceptable losses, battery performance and manufacturing cost, in a practical implementation. For example, finger width may be minimized to minimise eddy currents, however reducing the width may increase the internal resistance of the battery. Minimising the finger spacing maximises the electrode surface area and thereby the performance of the electrode, however it may be costly to manufacture an electrode with very small finger spacing. Minimising the thickness of the fingers also minimises the fraction of the skin depth at the drive frequency that those fingers occupy, however, typically, the thinner the fingers the more delicate and expensive they are to manufacture.

In some lithium-polymer battery technologies, a metallic comb structure of an electrode collector may be combined with a continuous polymer electrode layer to form each electrode 6. In the present embodiment, the electrode pattern is formed on both sides of a polymer substrate (e.g. as when making a double-sided flexible PCB). If a conductive polymer layer is required to form the finger pattern, this may be coated onto both sides of the substrate. In another embodiment, the electrodes 6 are manufactured by forming a metallic electrode comb structure on a sacrificial substrate and then transforming it onto a continuous polymer electrode layer. In another embodiment, the metallic electrode comb structure is patterned directly onto a continuous polymer electrode layer. In yet another embodiment, both the electrode collector and polymer electrode material may be patterned to have the finger (comb) structure, although this approach may in some circumstances result in some loss of battery performance.

One advantage of the cell construction in the present embodiment is that it allows an un-shielded inductive power receiver coil (being a secondary coil in an inductive power transfer system) to be located directly next to the cell without excessive heating or excessive degradation of coupling of the secondary coil to the primary coil in the system. The inductive power receiver coil (secondary coil) may, for example, take the form of a disk-like planar circular coil, with or without permeable core, or a lateral bar-like coil wound around a permeable core.

FIGS. 3A and 3B are schematic diagrams which illustrate the above-mentioned arrangements of a secondary coil for use in an inductive power transfer system (the system having a corresponding primary coil operable to generate a time-varying electromagnetic field) adjacent to the battery 1. In FIG. 3A (which shows a perspective view), a disk-like planar circular coil 20 is positioned with its plane adjacent to a main face of the battery 1, and in FIG. 3B (which shows a cross-sectional view), a cylindrical-form coil 22 wound around a bar-like core 24 is provided with its coil axis parallel to a main face of the battery 1.

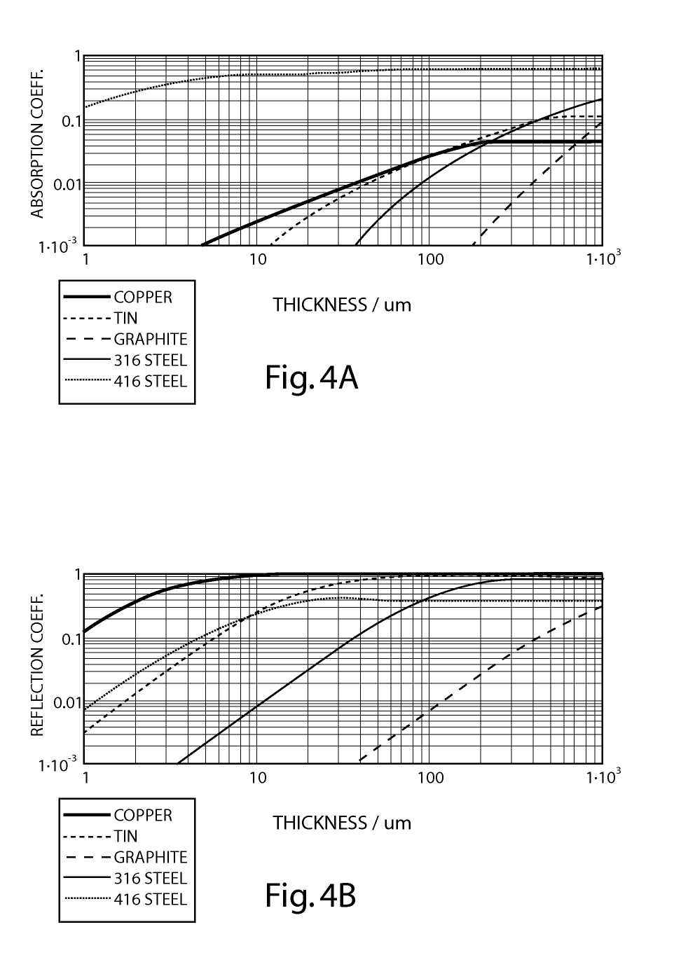

Typical absorption (loss) coefficients for different thickness layers of various materials are shown in the plot of FIG. 4A. Generally speaking, permeable materials are unattractive, as can be seen from the trace for a magnetic steel (416 stainless steel), since a high permeability results in a small skin depth. Use of a foil casing of a lower conductivity metal than aluminium alloys is one option. A non-magnetic 316 stainless steel or titanium alloy foil, for example, would provide lower losses than an aluminium alloy of similar thickness. High reflection coefficients may result in loss of coupling and generally are unattractive for use with a disk-like receiver coil without a core. FIG. 4B presents a plot of typical reflection coefficients for different thickness layers of various materials. Absorption and reflection coefficients can also be calculated for more complex layer structures. A design goal for implementation of one embodiment of the present invention may, for example, be to keep the total absorption coefficient below 0.5% and the reflection coefficient below 10%. Such a battery may then be used directly next to a wireless power receiver, such as a secondary coils as mentioned above.

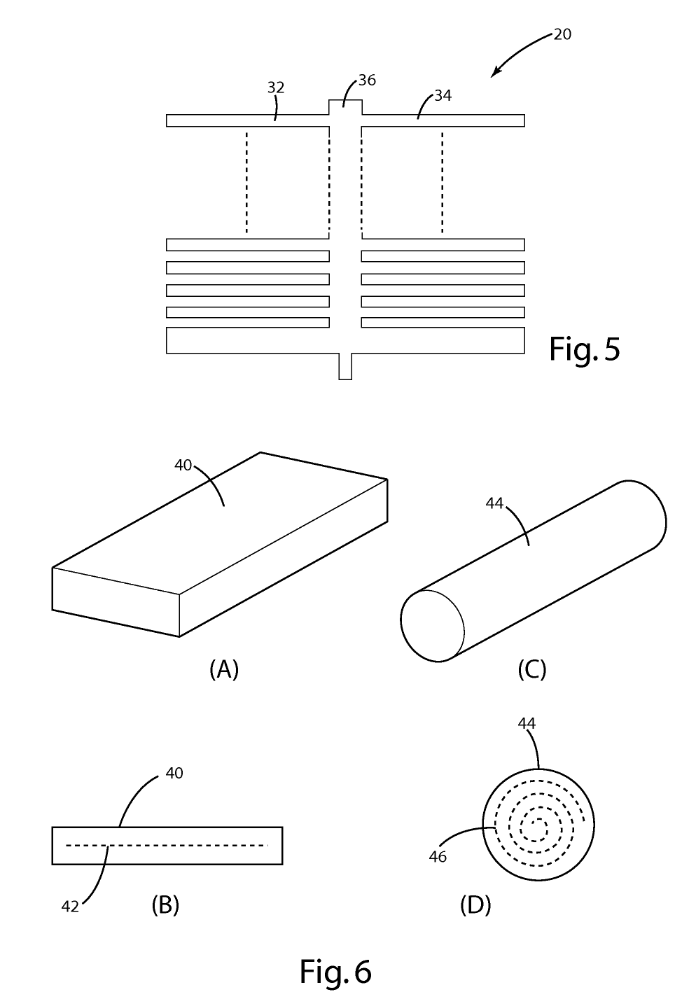

FIG. 5 is a schematic topological view of a part 30 of an electrode 6 which may be used interchangeably with part 10 of FIG. 2. Of course, parts 10 and 30 could be used together (for example in different electrodes or in the same electrode on different faces of a substrate) in a battery according to one embodiment of the present invention.

Electrode part 30 includes two sets of fingers 32 and 34 which project in opposite directions from a common portion 36. Common portion 36 is positioned towards the centre of electrode part 30 (whereas the common portion in part 10 of FIG. 2 is positioned towards, or even at, one side of the part). It will be appreciated that, compared to electrode part 10 and assuming a similar scale, fingers 32 and 34 are around half the size (in terms of length) of fingers 12, and may therefore be stronger (less likely to break) than fingers 12, and lead to a reduced internal battery resistance.

FIG. 6 is a schematic diagram useful for appreciating two possible forms of battery 1. In FIG. 6A (perspective view), battery 1 in one embodiment has a prismatic configuration 40. The stacked layer of electrodes 6 (and other central layers) as in FIG. 1 may therefore be provided in a flat configuration 42 in such a battery, as shown in FIG. 6B (cross-sectional view). In FIG. 6C (perspective view), battery 1 has in another embodiment a cylindrical configuration 44. The stacked layer of electrodes 6 (and other central layers) as in FIG. 1 may therefore be provided in a rolled configuration 46 (like a “Swiss roll”) in such a battery, as shown in FIG. 6D (cross-sectional view). Of course, the present invention extends, in other embodiments, to other cell configurations, such as button- or coin-cell configurations.

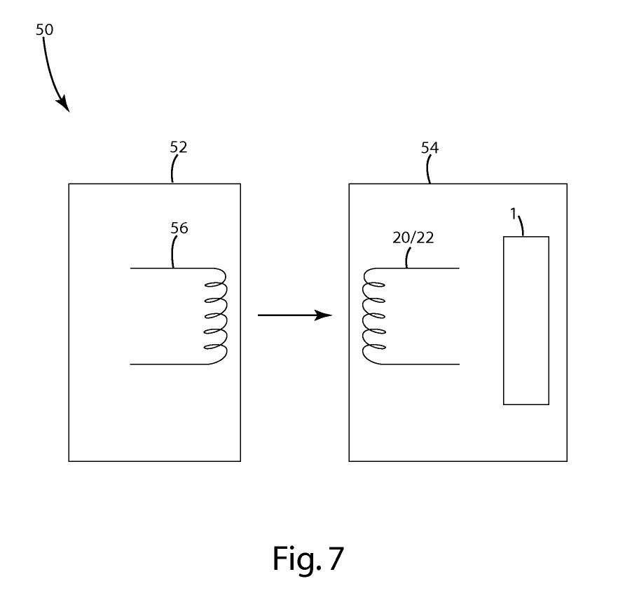

FIG. 7 is a schematic diagram of an inductive power transfer system 50 according to one embodiment of the present invention. System 50 includes a primary unit 52 and a secondary unit 54.

Primary unit 52 includes a primary coil 56, and secondary unit 54 includes a secondary coil 20/22 and a battery 1. Primary unit 52 is operable to employ its primary coil 56 to generate a time-varying electromagnetic field. The secondary coil 20/22 in secondary unit 54 is configured to couple with that field when in proximity to the primary unit 52 such that a current is induced therein. In that way, power is transferred wirelessly by electromagnetic induction from primary unit to secondary unit.

In secondary unit 54, the secondary coil 20/22 may be connected to supply the received power (by way of the induced current) to the battery 1 (or, more generally, to an electrical-energy storage device of the secondary unit) and/or to other circuitry of that secondary unit 54.

Although not shown in FIG. 7, it will be appreciated that the system 50 may include more than one primary unit 52 and/or more than one secondary unit 54. For example, one primary unit 52 may transfer power simultaneously to more than one secondary unit 54. Similarly, one secondary unit 54 may receive power simultaneously from more than one primary unit 52.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An electrical-energy storage device configured for use in a time-varying electromagnetic field, the storage device comprising:
an electrode at least part of which is configured so as to hinder the ability of eddy currents induced by said field to circulate therein,
wherein said electrical-energy storage device has an absorption coefficient less than 0.5% and a reflection coefficient less than 10%.

2. A storage device as claimed in claim 1, wherein said part of the electrode is shaped so as to hinder the ability of eddy currents induced by said field to circulate therein.

3. A storage device as claimed in claim 1, wherein the structure of said part of the electrode has a pattern which hinders the ability of eddy currents induced by said field to circulate therein.

4. A storage device as claimed in claim 1, wherein said part of the electrode is configured such that there are substantially no closed loops around which eddy currents may flow.

5. A storage device as claimed in claim 1, wherein said part of the electrode is metallic.

6. A storage device as claimed in claim 1, wherein said part of the electrode is in the form of one or more fingers electrically connected to the rest of the electrode at one end only.

7. A storage device as claimed in claim 6, wherein the or each said finger has a substantially square or rectangular cross-section.

8. A storage device as claimed in claim 6, wherein the or each said finger is dimensioned so as to hinder the ability of eddy currents induced by said field to circulate therein.

9. A storage device as claimed in claim 6, wherein said part of the electrode is in the form of a plurality of such fingers electrically connected together at one end only.

10. A storage device as claimed in claim 9, wherein said fingers and such an electrical connection therebetween make up substantially all of said part of the electrode.

11. A storage device as claimed in claim 9, wherein said fingers are substantially straight.

12. A storage device as claimed in claim 9, wherein each said finger of said electrode has a substantially uniform width along its length.

13. A storage device as claimed in claim 9, wherein the fingers of said electrode have substantially the same width as one another.

14. A storage device as claimed in claim 9, wherein the fingers of said electrode have substantially the same length as one another.

15. A storage device as claimed in claim 9, wherein a width of the fingers of said electrode is substantially small compared to a width or a length of said electrode part.

16. A storage device as claimed in claim 9, wherein a width of the fingers of said electrode is less than 0.25 mm and optionally in the range 0.1 to 0.2 mm.

17. A storage device as claimed in claim 9, wherein a width of a spacing or each such spacing between adjacent fingers of said electrode is substantially small compared to a width or a length of said electrode part.

18. A storage device as claimed in claim 9, wherein a width of a spacing or each such spacing between adjacent fingers of said electrode is less than 0.25 mm and optionally in the range 0.1 to 0.2 mm.

19. A storage device as claimed in claim 9, wherein the fingers of said electrode are all joined to the same common portion of the electrode.

20. A storage device as claimed in claim 19, wherein said common portion is located toward one side of said electrode, such that the fingers project from that side to the opposite side of the electrode.

21. A storage device as claimed in claim 19, wherein said electrode comprises two sets of such fingers projecting in opposite directions from the common part of the electrode.

22. A storage device as claimed in claim 21, wherein said common portion is located towards the centre of said part of the electrode.

23. A storage device as claimed in claim 9, wherein the part of the electrode having said fingers is generally in the form of a sheet having one or more slits therein each forming a spacing between adjacent fingers of the electrode.

24. A storage device as claimed in claim 23, comprising a plurality of such electrodes whose parts generally in the form of a sheet are layered one on top of the other in a stack.

25. A storage device as claimed in claim 24, wherein said stack comprises layers of electrolyte or separating layers interleaved between adjacent said electrodes.

26. A storage device as claimed in claim 24, having a prismatic form, wherein said stack is provided in a flat configuration within said storage device.

27. A storage device as claimed in claim 24, having a cylindrical form, wherein said stack is provided in a rolled configuration within said storage device.

28. A storage device as claimed in claim 23, wherein said time-varying electromagnetic field has a fundamental frequency, and wherein a thickness of said sheet for the or each said electrode is less than a predetermined fraction of a skin depth at the fundamental frequency.

29. A storage device as claimed in claim 28, wherein said fundamental frequency is in the range of a few tens of kHz to a few tens of MHz, optionally in the range 10 to 500 kHz.

30. A storage device as claimed in claim 28, wherein said predetermined fraction is around ⅙ to 1/20.

31. A storage device as claimed in claim 28 when read as appended to claim 24, wherein a combination of said thicknesses of said electrode parts is less than said predetermined fraction of a skin depth at the fundamental frequency.

32. A storage device as claimed in claim 28, wherein the sheet for the or each said electrode is formed of copper, aluminium, silver, silver-loaded ink, carbon lithium, lithium-carbon or a metal oxide with a thickness of 0.01 mm to 0.2 mm.

33. A storage device as claimed in claim 6, wherein the or each said electrode comprises a metallic sheet having said part comprising one or more fingers provided on a face of a polymer substrate.

34. A storage device as claimed in claim 33, wherein the or each polymer substrate is continuous, not having such a finger or such fingers.

35. A storage device as claimed in claim 33, wherein the or each electrode comprises two such metallic sheets provided on opposite faces of its said polymer substrate.

36. A storage device as claimed in claim 1, having a foil casing that is around 10 to 30 microns thick.

37. A storage device as claimed in claim 1, further comprising a coil for receiving power inductively when in such a time-varying electromagnetic field.

38. An electrical-energy storage device configured for use in a time-varying electromagnetic field whose variations have a fundamental frequency, the storage device comprising:
an electrode at least part of which is generally in the form of a sheet having one or more slits therein passing from within the sheet to an edge of the sheet and arranged such that the sheet is in the form of a plurality of strips connected together at one end only, said electrode having a thickness that is less than a predetermined fraction of a skin depth at the fundamental frequency; and
a casing around said electrode wherein the time-varying electromagnetic field can penetrate or pass through the casing with little or no loss.

39. An electrical-energy storage device configured for use in a time-varying electromagnetic field, the storage device comprising:
an electrode comprising a plurality of strips connected together so as to hinder the ability of eddy currents induced by said field to circulate therein,
wherein said electrical-energy storage device has an absorption coefficient less than 0.5% and a reflection coefficient less than 10%.

40. An electrical-energy storage device configured for use in a time-varying electromagnetic field whose variations have a fundamental frequency, the storage device comprising:
an electrode at least part of which is generally in the form of a sheet whose thickness is less than a predetermined fraction of a skin depth at the fundamental frequency.

41. A storage device as claimed in claim 40, comprising a plurality of such electrodes whose parts generally in the form of a sheet are layered one on top of the other in a stack.

42. A storage device as claimed in claim 41, wherein a combination of said thicknesses of said electrode parts is less than said predetermined fraction of a skin depth at the fundamental frequency.

43. A storage device as claimed in claim 1, wherein said part of the or each said electrode is a major part of or substantially all of that electrode.

44. An electrical-energy storage device configured for use in a time-varying electromagnetic field whose variations have a fundamental frequency, the storage device comprising:
a casing, such as a foil casing, whose thickness is less than a predetermined fraction of a skin depth at the fundamental frequency.

45. A storage device as claimed in claim 1, being a battery or a supercapacitor or a hybrid battery-capacitor device.

46. An electrical or electronic device comprising a storage device as claimed in claim 1.

47. An electrical or electronic device as claimed in claim 46, suitable for receiving power wirelessly by electromagnetic induction when located in a time-varying electromagnetic field, the electrical or electronic device further comprising:
a coil configured to couple with such a field so that a current is induced therein; and
circuitry for providing said current to said storage device and/or to other circuitry in said electrical or electronic device so as to provide the received power thereto.

48. An electrical or electronic device as claimed in claim 47, wherein said coil is positioned adjacent to said storage device.

49. A combination, comprising a storage device as claimed in claim 1 and a coil for use in receiving power inductively when in such a time-varying electromagnetic field.

50. An inductive power transfer system, comprising:
a primary unit having a primary coil operable to generate a time-varying electromagnetic field; and
a secondary unit suitable for receiving power wirelessly by electromagnetic induction from the primary unit when located in said time-varying electromagnetic field, the secondary unit comprising:
a secondary coil configured to couple with said field so that a current is induced therein;
a storage device as claimed in claim 1; and
circuitry for providing said current to said storage device and/or to other circuitry in said secondary unit so as to provide the received power thereto.

51. A method of manufacturing a storage device as claimed in claim 6, the method comprising:
forming said finger or fingers by photolithography and chemical etching, or by a screen printing process, or by a stamping process.

52. (canceled)
